(19) United States
(12) Patent Application Publication
(10) Pub. No.: US 2016/0266779 A1
(43) Pub. Date: Sep. 15, 2016

(54) INSIGHT EXTRACTION, DISCOVERY AND DISTRIBUTION

(71) Applicant: Microsoft Technology Licensing, LLC, Redmond, WA (US)

(72) Inventors: Graham Andrew Michael Sheldon, Bellevue, WA (US); Sedat Gokalp, Bellevue, WA (US)

(21) Appl. No.: 14/657,615

(22) Filed: Mar. 13, 2015

(51) Int. Cl. G06F 3/0484

(52) U.S. Cl. CPC G06F 3/04847; G06F 3/04842

(57) ABSTRACT

In one example, user interactions with a computing system are detected, and information that represents an insight is identified and extracted from the detected user interaction. If the information is relatively sensitive, the user is asked to approve of storing the insight for potential access by others. Other users can then request insights (or requests can be automatically generated) about certain items, and the stored insights can be searched and returned in response to the request. If the insights to be returned contain sensitive material, then the owner of the insight can be asked to approve dissemination of the insight to the requestor or requesting system.

### BACKGROUND

Computer systems are currently in wide use. Some organizations employ a wide variety of different types of computing systems and applications, in order to perform operations or tasks for the organization.

For example, many organizations have a variety of different communication systems. They can include electronic mail systems, messaging systems, social or business network systems, telephonic, cellular or other similar communication systems, etc. In addition, the same organization may have organization-specific applications that allow users to perform tasks. Some such applications can include customer relations management systems, enterprise resource planning systems, document management systems, meeting and calendar systems, etc. Such computing systems can include a wide variety of other systems as well.

People who work for the organization may use any or all of these applications in order to perform a wide variety of different types of tasks. Many of the tasks are unstructured. For instance, a workflow within a CRM system may have a pre-defined structure. Therefore, when a worker performs the workflow, the result is captured in a structured way. However, at a given step within that workflow, a user may perform other, unstructured steps. For instance, during a workflow that generates a quote from an opportunity, the user may send emails, perform information retrieval queries, engage in research on social or business networks, or other things, in an unstructured way, in order to obtain information. This type of information can be helpful to the user.

The discussion above is merely provided for general background information and is not intended to be used as an aid in determining the scope of the claimed subject matter.

### SUMMARY

Some organizations have many different employees or users. When all of them do this, some of the employees or users may gain insights about another organization, person, product, etc., that may be helpful to other users within the organization. Regardless of whether the insights are gained through structured activity or unstructured activity, they are often not captured, in a way that makes them accessible to other users in the organization. This can be due, for instance, due to security permissions, or it can be because the insights are simply not easily discoverable by the other users.

In one example, user interactions with a computing system are detected, and information that represents an insight is identified and extracted from the detected user interaction. If the information is relatively sensitive, the user is asked to approve of storing the insight for potential access by others. Other users can then request insights (or requests can be automatically generated) about certain items, and the stored insights can be searched and returned in response to the request. If the insights to be returned contain sensitive material, then the owner of the insight can be asked to approve dissemination of the insight to the requestor or requesting system.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one example of a computing system architecture.

FIG. 2 is a more detailed block diagram of one example of an insight generation and distribution architecture.

FIGS. 3A and 3B (collectively referred to herein as FIG. 3) show a flow diagram illustrating one example of the operation of the architecture shown in FIG. 2 in discovering insights based on user interactions with a computing system.

FIGS. 4A and 4B (collectively referred to herein as FIG. 4) show a flow diagram illustrating one example of the operation of the architecture shown in FIG. 2 in distributing insights for approval and for distribution to requestors.

FIGS. 5A-5M show examples of user interface displays.

FIG. 6 shows one example of the architecture illustrated in FIG. 1, in a cloud computing architecture.

FIGS. 7-9 show various examples of mobile devices that can be used in the architectures shown in the previous figures.

FIG. 10 is a block diagram of one example of a computing environment that can be used in the architectures shown in the previous figures.

### DETAILED DESCRIPTION

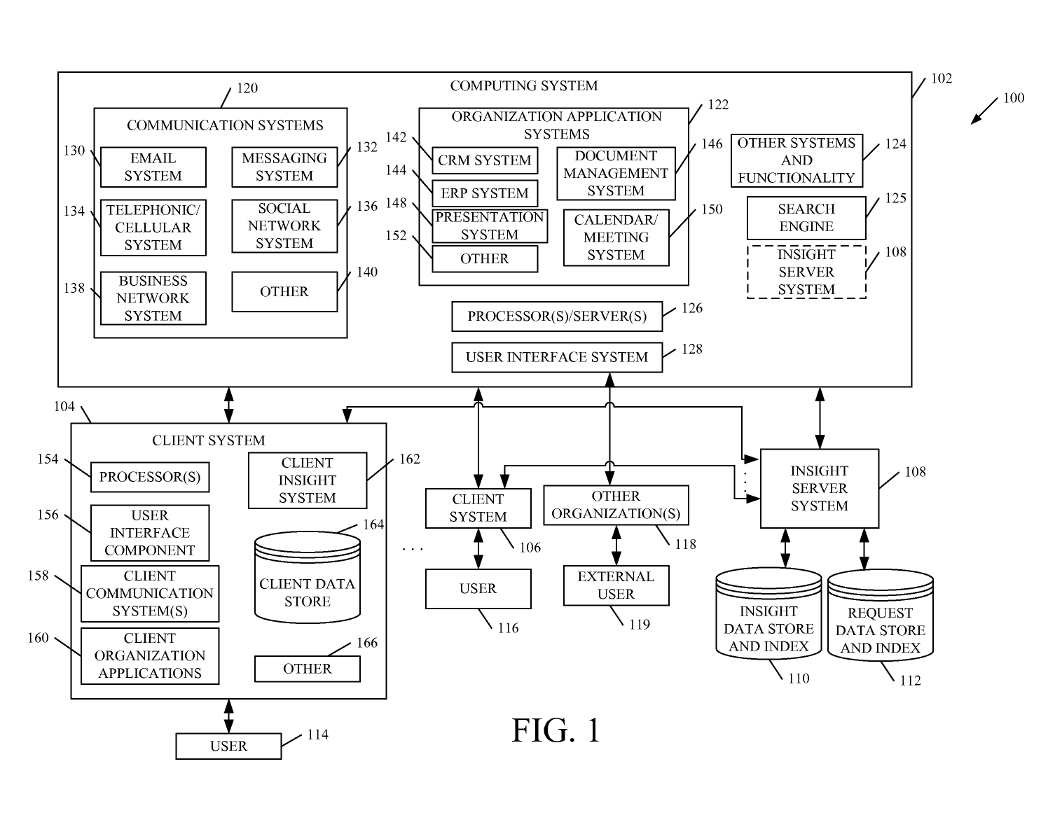

FIG. 1 is a block diagram of one example of a computing system architecture 100. Computing system architecture 100 illustratively includes computing system 102, a set of client systems 104-106, and an insight server system 108 that has access to an insight data store and index 100 and to a request data store and index 112. Architecture 100 also shows that, in one example, users 114-116 interact with client systems 104-106 in order to access, control and manipulate computing system 102 and insight server system 108. Architecture 100 also illustrates that other organizations 118 can illustratively provide information to, or otherwise access, computing system 102.

Computing system 102 is illustratively a computing system that is used by an organization. Therefore, it can have a wide variety of different systems deployed within it. For instance, it can have communication systems 120, organization application systems 122, other systems and functionality 124, and search engine 125. It also illustratively has a set of processors or servers 126, and user interface component 128. FIG. 1 also shows that, in one example, insight server system 108 can be deployed within the computing system 102 of the organization, or it can be separate.

Communication systems 120 can include, for instance, email systems 130, messaging systems 132, telephonic/cellular systems 134, social network systems 136, business network systems 138, or a wide variety of other communication systems 140. Organization application systems 122 illustratively run organization applications. They can be server side applications and can, themselves, include customer relations management (CRM) systems 142, enterprise resource planning (ERP) systems 144, document management systems 146, presentation systems 148, calendar/meeting systems 150, and a wide variety of other systems 152.

Each client system 104 can include one or more processors 154, user interface component 156, client communication systems 158, client organization applications 160, a client insight system 162, a client data store 164, and other items 166. The client communication systems 158 can be client side components of the organization communication systems 120, or they can be separate communication systems. Similarly, the client organization applications 160 can be client side components of the organization applications 122 or the client organization applications can be separate applications as well.

FIG. 1 shows that a wide variety of different users 114-116, and other organizations 118, can communicate with one another through computing system 102. They can also communicate with one another using separate, client-side systems.

Through all of the various user interactions with system 102, insight server system 108 illustratively identifies and extracts insights based on those interactions. It will be noted that some of the interactions may be structured interactions within a given application run by systems 122. In another example, the interactions are unstructured interactions, such as email sent through email system 130, other messaging communications (e.g., using a mobile device such as a tablet or smart phone) through messaging system 132, or telephonic/cellular system 134, or interactions with social network system 136 or business network system 138. They can also be search results based on searches conducted by search engine 125 (or a client-side search engine). Of course, these are only examples of the different types of interactions that can give rise to insights.

It will be appreciated that, because there may be a large number of users 114-116, a given user may have an insight with respect to a topic but it will not be known to other users, even though it may be relevant to those users. Similarly, a given user may have gained the insight through sensitive communications (such as through personal electronic mail transmissions or personal messages, or through personal telephone or cell phone calls, etc.). Similarly, the insight, itself, may involve sensitive content. For instance, the insight may involve salary information, pricing information, or a wide variety of other sensitive content. Therefore, it may be that the particular user that has gained that insight (e.g., the insight owner) may not wish to share it with anyone else, or may wish to share it with only a limited group of people.

A scenario may be helpful to illustrate the operation of the system. Assume that user 114 often communicates with an external user 119 who is at another organization 118 about technology startup organizations. The communication is illustratively performed through either a server-side email system 130 or a client-side email system. Client insight system 162 and insight server system 108 illustratively record the interactions of user 114 with the external user 119 along with information about the external user (such as the company he or she works for), and analyzes the content of those communications to identify that they are about technology startup companies. It also illustratively generates a strength metric indicating a strength of the insight. For instance, if the frequency of the communications is relatively high, then the strength metric may be higher. If the communication is isolated, or relatively infrequent, then the metric may be lower. Assume now that user 116 is trying to sell a product to the same external user 119 at organization 118. Insight server system 108, and the client insight system on client system 106, illustratively detects this based on the interactions of user 116 and informs user 116 that another user knows the external user 119. The system allows user 116 to send a request to that individual (that is, it allows user 116 to send a request to user 114, although the identity of user 114 is not yet known to user 116) to disclose their identity (the identity of user 114) and the nature of the relationship between themselves (user 114) and the external user 119. If user 114 accepts that request, then user 116 is informed about the nature of the relationship between user 114 and external user 119. User 116 may then ask user 114 if he or she will introduce user 116 to the external user 119. It will be noted that, as described in greater detail below, the system can automatically surface that an insight exists based on the interactions of user 116, or user 116 can explicitly request insights related to external user 119.

A brief overview of how insights are handled will now be provided. In accordance with one example, insight server system 108 and client inside system 162 illustratively operate to identify insights through various user interactions or other operations relative to computing system 102. Insight records, that represent those insights, can be generated from data extracted from the user interactions. The insight records can be stored in insight data store and index 110. Thus, when other users perform actions that may benefit from the insight, the insights can be surfaced from data store 110, to those particular users. In addition, when an insight involves sensitive material, the insight owner is asked to approve of storing and indexing the insight record in data store 110. Then, when the insight is to be surfaced for a user, the insight owner is again asked to approve of the sensitive insight record being surfaced for that particular user. In another example, users may expressly request insights from insight server system 108. In that case, if there are insights responsive to the request, they are surfaced for the user using the same process. If there are not yet any relevant insights in data store 110 that are responsive to the request, then the request is illustratively stored in request data store and index 112. When subsequent insights are gained, that are responsive to any of the requests in request data store and index 112, the requestors that generated those requests are notified and the insights can be surfaced for them. This is described in greater detail below.

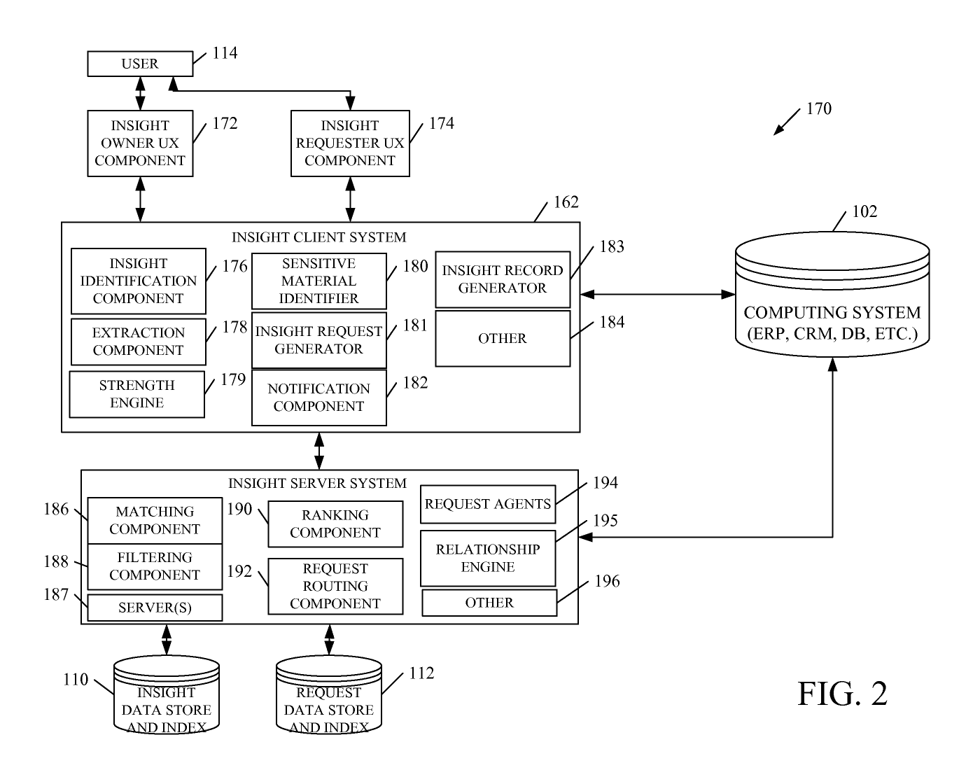

FIG. 2 is a block diagram of one example of an insight generation and distribution architecture 170, in more detail. Some of the items in architecture 170 are similar to those shown in architecture 100 (in FIG. 1) and they are similarly numbered. Some of the items are now shown in more detail in FIG. 2. It will also be noted that, while some components and functionality are shown in client system 104 and others are shown in server system 108, the arrangement shown is only one example. Some or all functionality can be switched from one system to the other. All of those architectures are contemplated herein.

Architecture 170 thus includes insight client system 162, and insight server system 108, that has access to data stores 110 and 112. Systems 104 and 108 also illustratively have access to computing system 102. Architecture 170 also shows that, in one example, it includes an insight owner user experience component 172 and an insight requestor user experience component 174. Component 172 illustratively conducts a user experience (as is described in greater detail below) for a user 114 who is the owner of a particular insight. Component 174, on the other hand, illustratively conducts a user experience for a particular user 114 that is requesting insights relative to a given subject matter. It will be noted that components 172 and 174 can be part of insight client system 104, or they can be separate. They are shown as being separate for the sake of example only.

In the example shown in FIG. 2, insight client system 104 illustratively includes insight identification component 176, extraction component 178, sensitive material identifier 180, insight request generator 181, notification component 182, insight record generator 183, and it can include other items 184. Insight identification component 176 illustratively detects user interactions and other information and determines whether those interactions represent a particular insight that should be processed and stored in data store 110. Extraction component 178 extracts information from the user interactions (such as the identity of the user, who the user is corresponding with or otherwise interacting with, the type of interaction, the context of the interaction such as the application the interaction is received through and the context of that application when the interaction is detected, etc.). Sensitive material identifier 180 determines whether the information in the insight is sensitive. Insight request generator 181 automatically generates requests to surface insights and sends the request to server system 108. Notification component 182 notifies users 114 of insights relative to different types of information and contexts and performs other notification functions. Insight record generator 183 generates insight records when an insight is detected, and provides it to server system 108 for storage in data store 110.

Insight server system 108 illustratively includes matching component 186, server(s) 187, filtering component 188, ranking component 190, request routing component 192, request agents 194, relationship engine 195 and it can include other items 196. Matching component 186 illustratively matches insight requests from client system 104 against insights that may be stored in insight data store and index 110. Filtering component 188 filters irrelevant insights, and ranking component 190 illustratively ranks the insights surfaced from data store 110, by matching component 186, based upon how responsive they are to a particular request. For instance, component 190 may rank the insights based upon relevancy, based upon recency, based on how often they are requested or based upon a wide variety of other characteristics or ranking criteria.

Request agents 194 illustratively control interactions between insight server system 108 and request data store and index 112. Therefore, they can illustratively search for requests in data store 112 that are relevant to newly recorded insights. They can also extract requests from data store 112 and provide them to request routing component 192. Request routing component 192 routes the requests to the various owners or requestors where approval is needed.

Relationship engine 195 identifies relationships among various insights in data store 110. All of these are described in greater detail below.

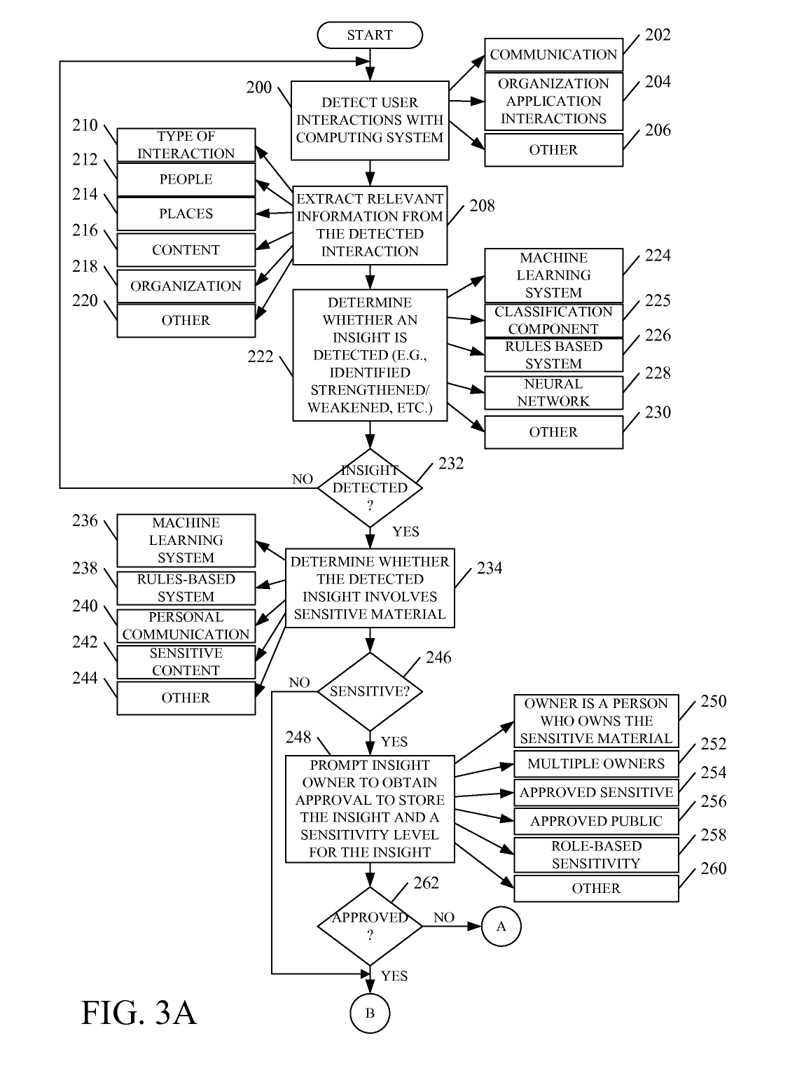

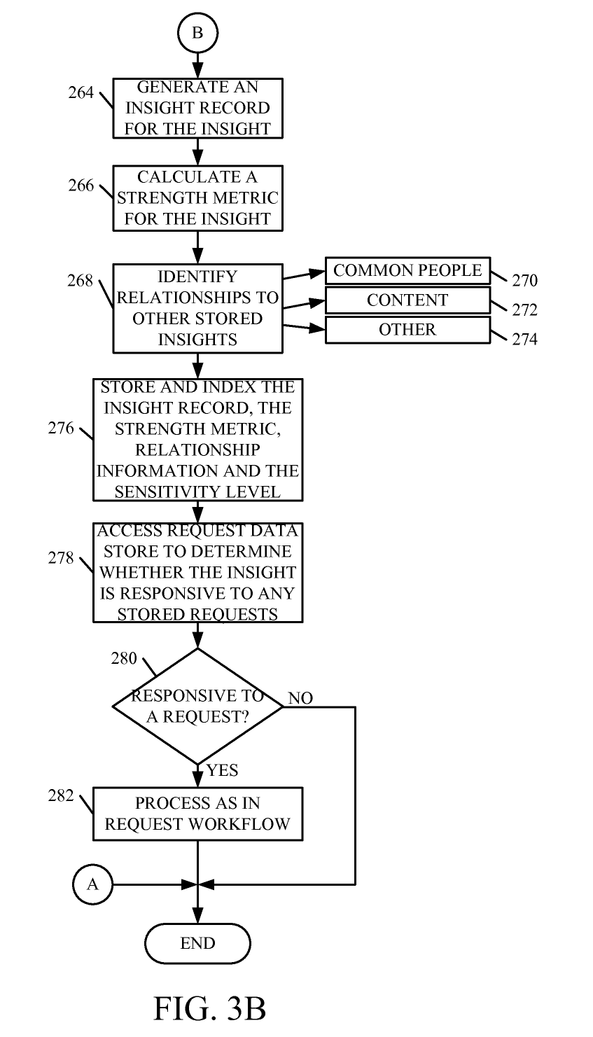

FIGS. 3A and 3B (collectively referred to herein as FIG. 3) show a flow diagram illustrating one example of the operation of architecture 100 (shown in FIG. 2) in discovering insights based on user interactions and other information in computing system 102, in generating insight records corresponding to those insights, and in storing them in insight data store and index 110. It will be assumed for the sake of the present discussion that user 114 will be the owner of the particular insight that is being discovered and recorded.

Insight owner UX component 172 first detects user interactions from user 114 with computing system 102 or client system 104, or both. This is indicated by block 200 in FIG. 3. For instance, the user interactions can be communications 202, using one of communication systems 120, or another communication system. They can be any of a wide variety of different organization application interactions 204 with any of the organization application systems 122, or other systems. They can be search results using search engine 125, or they can be a wide variety of other interactions 206.

Extraction component 178 then extracts relevant information from the detected interaction. This is indicated by block 208. For instance, it can extract the type of interaction 210. This may be, for instance, an email, a message or call, a meeting request, a search query, etc. It can also illustratively extract the identity or characteristics of the various people 212 involved in the interaction. This may include the attendees at a meeting, the recipients of an email, etc. Further, it can include any places 214 corresponding to the interaction. For instance, it may be the identity of an organization where the recipients of the email work. It may be the location of a meeting. It may be places referenced in the content of the user interaction, etc. It can identify the context of the interaction, such as the context of an application the user is using, whether the user is using a mobile device or his or her desktop computer, the location of the user, etc. It also illustratively identifies the content of the interaction, itself. This is indicated by block 216. For instance, if the interaction is a meeting request, it may be the subject matter of the meeting request. If it is an email, it may be the semantic content of the email. In one example, extraction component 178 illustratively includes natural language processing components that parse the content of electronic mail messages, the subject matter lines in meeting requests, transcripts of telephone calls, the content of attachments to email messages, the content of search results, etc. It identifies the subject matter content or semantic content of that information as well, and extracts the content or keywords representing the content. The relevant information can include organizations 218 identified in the content, or a wide variety of other information 220.

Insight identification component 176 then determines whether an insight is detected (such as whether a new insight is identified, or an existing insight is affected) by the extracted information. This is indicated by block 222. It will be appreciated that insight record generator 183 can generate a record with the extracted information. Based on that record, insight identification component 176 can classify the information into one of a variety of different types of pre-defined insights. It can also classify the information into an unknown, or newly defined type of insight as well. In addition to component 176 (or instead of component 176) it will be appreciated that a wide variety of different types of machine learning systems 224 can be used as well. It can be a classifier 225. In addition, the component 176 that identifies whether an insight is detected can be a rules-based system 226. By way of example, the component can access a set of rules that define conditions for identifying a particular insight. This is only one example, however. The component can be a neural network 228, or a wide variety of other types of systems that can obtain the extracted information and determine whether a new insight is detected, or an already-existing insight is affected. The other types of components are indicated by block 230.

If no insight is detected, then the system simply reverts to block 200 where it continues to detect user interactions. This is indicated by block 232. However, if an insight is detected, then sensitive material identifier 180 determines whether the detected insight involves sensitive material. This is indicated by block 234. Again, sensitive material identifier 180 can include natural language processing components and a machine learning system 236 to identify the content of the detected user interactions and determine whether it corresponds to sensitive material. It can use a rules-based system 238, it can identify sensitive material in varying ways based on context, or it can be a wide variety of other systems.

In one example, the sensitivity of material can be pre-defined at different levels. Highly sensitive material may require the approval of the owner of that sensitive material for every request to surface it. Moderately sensitive material may be distributed to certain individuals (such as high ranking individuals at a corporation) without the owner's approval, but the dissemination to anyone else may need the owner's approval. These are only two examples of different types of sensitivity categories and a wide variety of others can be used as well.

The information can be determined to be sensitive for a variety of reasons. For instance, if it is a communication on a personal communication mechanism 240 (such as the user's cell phone, the user's personal email account, etc.), then it may be automatically determined to be sensitive. It can also be determined that the insight is sensitive if the content of the insight is sensitive. This is indicated by block 242. It can be determined that the detected insight involves sensitive material in other ways as well, and this is indicated by block 244.

For purposes of the present discussion, it is assumed that if the insight which has just been detected and identified includes sensitive material. In that case, the insight owner's approval is needed before the insight is indexed and stored in data store 110 for distribution to requestors. Thus, if, at block 246, identifier 180 determines that the insight is sensitive, then notification component 182 controls component 172 to prompt the insight owner (in this case, user 114 in FIG. 2) to obtain approval to store the insight. It can also prompt user 114 to specify a sensitivity level for the insight. This is indicated by block 248.

Again, for the purposes of the present discussion, the owner of the insight will be determined to be the person who owns the sensitive material. This is indicated by block 250. There may be multiple owners of a given insight. This is indicated by block 252. For instance, if an electronic mail message is sent by one user using a personal email account, and the content of the email contains the salary of a recipient of the email, then both the sender and the recipient of the email may be owners of an insight generated from that email, and may need to provide approval for the insight to be stored. Again the owner of the insight may approve the insight. The owner may also indicate that it is to be considered sensitive. This is indicated by block 254. On the other hand, the owner may approve the insight, but indicate that it may be made publically available. This is indicated by block 256. The owner may approve the insight, but indicate it is to be subjected to a type of role-based sensitivity. This is indicated by block 258. For instance, the owner of the insight may indicate that the insight is only to be provided to people in the organization that have a higher role than the owner, within a role hierarchy. The approval can be provided in other ways as well, and this is indicated by block 260.

In one example, the owner of the insight is prompted by displaying a notification with a user input mechanism. The notification illustratively describes the insight that was detected, and the information that will be logged or stored for distribution to insight requestors. It also illustratively includes a user input mechanism that can be actuated by the user in order to approve the storing of the insight.

If, at block 262, the notification component 182 detects that the user has approved the insight, then insight record generator 183 generates an insight record for the insight including all of the desired information that describes the insight, and characteristics of the insight, etc. This is indicated by block 264. The insight record may be generated according to a pre-defined schema or structure, or in other ways.

Strength engine 179 then calculates a strength metric for the insight. This is indicated by block 266. For instance, there may be characteristics of the detected interaction that indicate that the insight is highly reliable, or is a very strong insight. As an example, in the scenario discussed above, if user 114 sends a large number of electronic mail messages to external user 119, and the content is always the same, that may indicate a first strength. However, if the content is widely varying, or the frequency of the communications are lower, that may indicate a different strength. These are only examples of the different characteristics or criteria that can be used in calculating a strength metric for the insight. The strength metric can also be included by generator 183 in the insight record.

Generator 183 then illustratively provides the insight record, along with the strength metric and sensitivity level (if any are designated by the owner) to insight server system 108. In one example, relationship engine 195 illustratively calculates any relationships between the insight record and other insight records in data store and index 110. For instance, it may be that the same user 114 sends a high quantity of emails to two different external users. In that case, one insight record may indicate that user 114 has a high degree of familiarity with one of the external users, and another insight record may indicate that user 114 has a high degree of familiarity with the other external user. These two insights may be related by engine 195 because they both originate from user 114. Of course, this is only one type of relationship that can be defined between different insights records. Identifying relationships to other stored insight records is indicated by block 268. Identifying them based on common people referenced in the insight records is indicated by block 270. Identifying them based on common content in the insight records is indicated by block 272, and identifying relationships for other reasons is indicated by block 274.

Insight server system 108 then stores and indexes the insight record, the strength metric, the relationship information, and the sensitivity level corresponding to the insight. This is indicated by block 276. All of this can be included in the insight record or it can be stored separately.

A request agent 194 then illustratively accesses request data store and index 112 to determine whether there are any unanswered requests in data store 112 that are related to the insight record that was just stored in data store 110. That is, agent 194 determines whether the new insight record that was just stored is responsive to any of the requests that are stored in data store 112. This is indicated by block 278. For instance, matching component 186 can determine whether the newly stored insight record matches any of the requests. Filtering component 188 can filter the various requests, and ranking component 190 can identify the highest ranking requests to which the newly stored insight record is responsive.

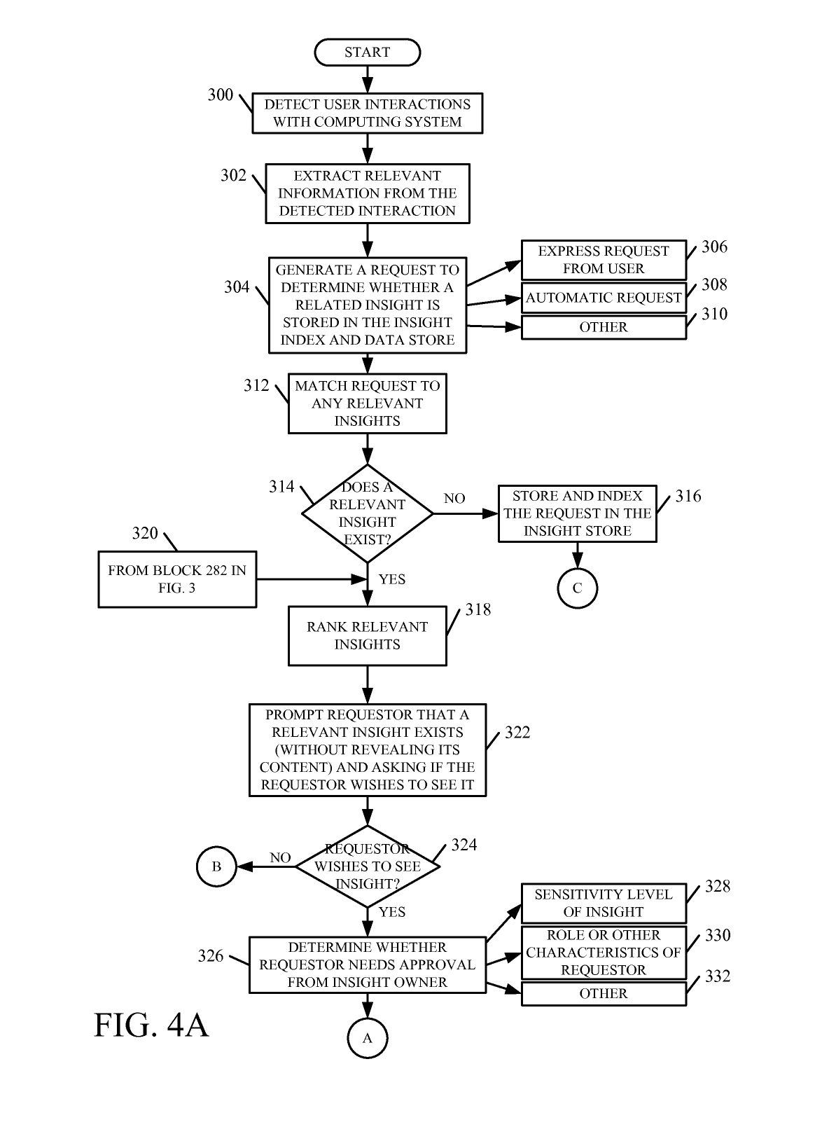

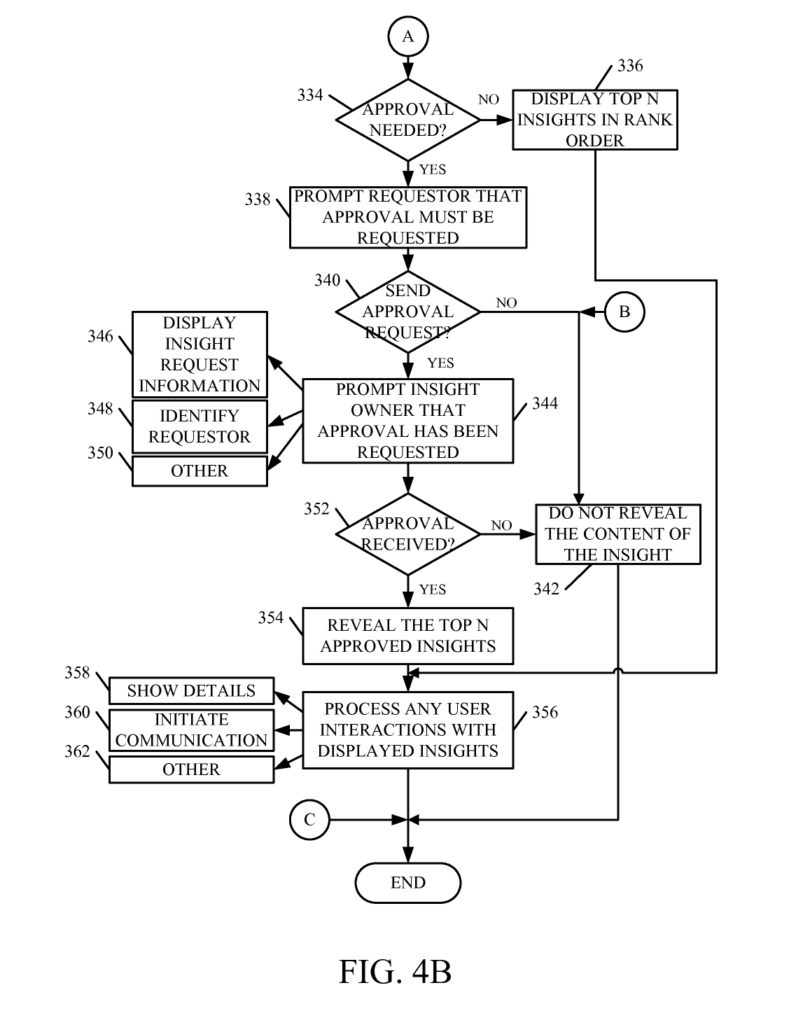

If the insight record is responsive to a stored request, then the insight record is processed in a request workflow as described in greater detail below with respect to FIG. 4. This is indicated by blocks 280 and 282, respectively.

FIGS. 4A and 4B (collectively referred to herein as FIG. 4) show a flow diagram illustrating one example of the operation of architecture 170 (shown in FIG. 2) in surfacing insight records for various users 114-116 of computing system 102, in response to requests. It will first be noted that insight requestor UX component 174 can detect user interactions and automatically request insights that are related to those user interactions. The system can then surface insights for the user 114, even if the user doesn't expressly ask for them. In another example, the user can generate an express request for related insights, that are related to the user's interactions. In that case, the system can surface insights as well. In yet another example, a previously submitted request can be stored in request data store 112. When a new insight is detected and stored in data store 110, that is responsive to the previously-submitted request, then the system can automatically detect this and surface the insights in response to the previously-submitted request as well. All three of these scenarios are described below with respect to FIG. 4.

In the example discussed herein, insight requestor UX component 174 first detects user interactions in which user 114 is interacting with client system 104 or computing system 102, or both. This is indicated by block 300 in FIG. 4. Again, as discussed above, the user interactions can be a wide variety of different types of interactions, such as communications, interactions with applications, meeting requests, presentations, information retrieval queries, etc.

Extraction component 178 then extracts relevant information from the detected interaction. This is indicated by block 302. Again, as discussed above, the relevant information can be pre-defined in a schema or other structure. The pre-defined schema or structure may vary based upon the type of interaction being detected, based upon an application, a context, or other computing component through which the action is taken, or based on a wide variety of other things. That information can then be provided to insight request generator 181. Request generator 181 illustratively generates a request to determine whether a related insight is stored in the insight data store and index 110. This is indicated by block 304. Again, the request can be generated based upon an express input from user 114, requesting insights. This is indicated by block 306. It can also be automatically generated, to automatically surface insights for user 114. This is indicated by block 308. It can be generated in other ways as well, as indicated by block 310.

Once the request is generated, matching component 186 illustratively matches the request against any relevant insights in insight data store and index 110. This is indicated by block 312. This can be done in a wide variety of different ways. For instance, the request may have a keyword section that identifies keywords (such as people, subject matter content, documents with an ERP or CRM system, organization names, or a wide variety of other items). The keywords can be matched against the index portion of data store 110 to identify any matching insight records. The matching can be performed in a wide variety of other ways as well. For instance, a natural language processing system can generate a logical form or other logical representation of the request and match it against a logical representation of the insight records. All of these, and other mechanisms for matching a request to an insight record, are contemplated herein.

If, at block 314, no relevant insight record is found in data store 110, then the request is stored and indexed in data store 112. This is indicated by block 316. Processing with respect to this request then ends until a relevant insight is detected and its record is stored in data store 110.

However, if, at block 314, it is determined that one or more relevant insight records are located in data store and index 110, then the relevant insights records that are identified by matching component 186 can be filtered by filtering component 188 and ranked by ranking component 190. This is indicated by block 318 in FIG. 4. It will also be noted that, a previously-submitted request may be stored in data store 112 and a newly-detected insight record is stored in data store 110. If the newly-detected insight record is relevant to the previously-submitted request, then processing enters the flow of FIG. 4 at block 318. This is indicated by block 320.

Once the relevant insight records are ranked, then the requestor (e.g., user 114) can be notified that there are insights, relevant to the user's interactions, that may possibly be surfaced for the requestor. For instance, a display can be generated that prompts the requestor and indicates that a relevant insight exists and asks the requestor whether he or she wishes to see that insight. This is all illustratively done without revealing the content of the insight, but only that it exists. This is indicated by block 322. In one example, the request routing component 192 generates a message to UX component 174 and component 174 displays a user interface display indicating that insights exist, and including a user input mechanism that can be actuated by the requestor in order to initiate the process of viewing those insights.

If the requestor actuates the user input mechanism to indicate that he or she wishes to see the insights, as indicated by block 324, the request routing component 192 determines whether the requestor needs approval from the insight owner, in order to see the request. This is indicated by block 326. This may be dependent on a wide variety of things. For instance, request routing component 192 can consider the sensitivity level of the insight as indicated by block 328. It can consider the role or other characteristics of the requestor as indicated by block 330. It can consider a wide variety of other information as well, and this is indicated by block 332. By way of example, if the insight has a sensitivity level that indicates that role-based approval is to be enforced, then request routing component 192 may illustratively determine whether the role of the requestor (user 114) meets the role threshold needed in order to see the insight record without approval. If not, then approval is needed. In another example, the insight may simply be marked as sensitive, indicating that approval is needed by any requestor to view the insight. Of course, the insight may be marked as public, in which case any requestor can see the insight, without approval. These are examples only.

It will also be appreciated that where more than one insight record is to be surfaced for the requestor, the approval process will be conducted with respect to each individual insight record. If the top N insight records have been identified as being responsive to the request, then all of those insight records will be processed to determine whether they need approval from the insight owner in order to be surfaced for this requestor.

In any case, if approval is not needed, as indicated by block 334, then the top N insight records are displayed, in rank order, for the requestor. This is indicated by block 336.

However, if, at block 334, approval is needed for one or more of the insights, then request routing component 192 prompts the requestor (through UX component 174) to see whether the requestor wishes to request approval from the insight owner. This is indicated by block 338. In one example, this can be done by controlling notification component 182 to send a user interface display notification to the requestor through UX component 174, indicating that the owner's approval is needed to see the insight. It may also illustratively include a user input mechanism that can be actuated in order to initiate the process of requesting the owner's approval. If the requestor does not request approval of the insight owner, as indicated by block 340, then the content of the insight record is not revealed to the requestor, as indicated by block 342.

However, if, at block 340, the requestor has requested approval from the insight owner, then request routing component 192 controls UX component 172 on the client system of the insight owner to prompt the insight owner that approval has been requested for one of his or her insights. This is indicated by block 344. In one example, this is done by displaying a user interface display that displays insight request information 346, such as the content of the particular insight record that is to be surfaced, relevant date information, how the insight was detected and stored, etc. In addition, it can also identify the requestor as indicated by block 348. It can include a wide variety of other information 350 as well. The prompt can also illustratively include a user input mechanism that can be actuated by the owner in order to approve or decline the request.

If, at block 352, the insight owner does not approve the request, then processing again proceeds to block 342 where the content of the insight record is not revealed to the requestor. However, if at block 352, the insight owner has approved the request, then the top N insight records are revealed to the requestor. This is indicated by block 354. Again, this can illustratively be done by having insight requestor UX component 174 display a user interface display that includes descriptive links to each of the top N insight records. The links can act as user input mechanisms to receive interaction by the requestor. Insight requestor UX component 174 then processes any user interactions with the displayed insights. This is indicated by block 356. For instance, the user may actuate a link and, in response, component 174 shows more details about the particular insight record. This is indicated by block 358. The user may actuate a user input mechanism to initiate communication with the insight owner, or with other people identified in the insight record. This is indicated by block 360. Of course, the user interactions with the displayed insights can include a wide variety of other interactions as well, and this is indicated by block 362.

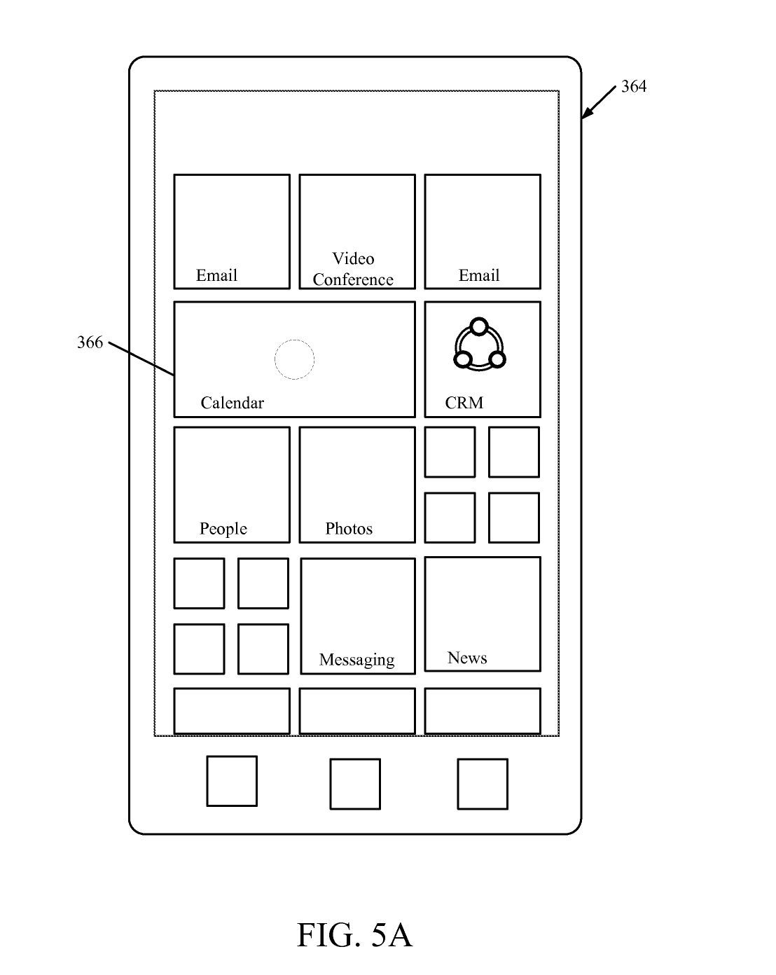

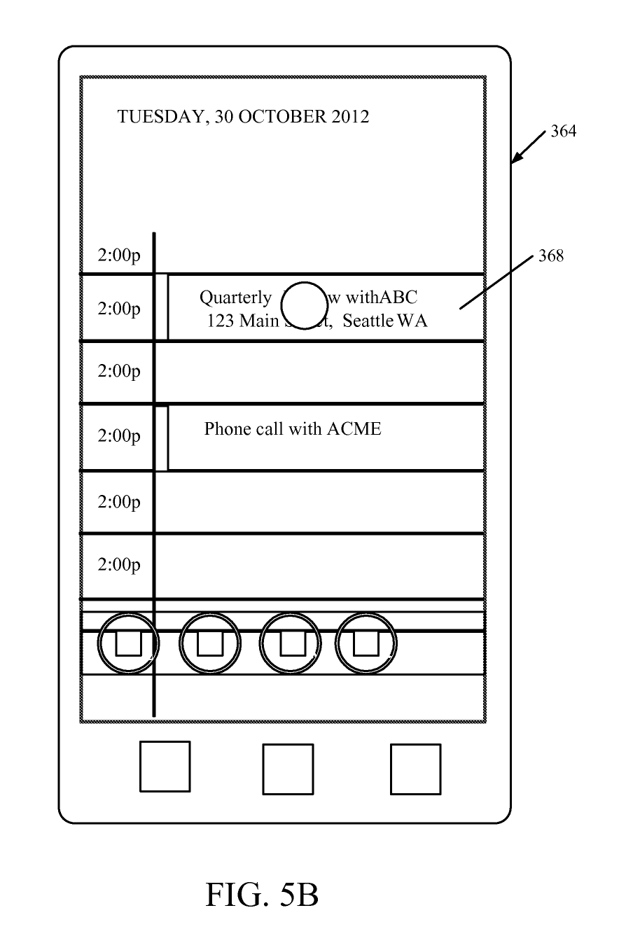

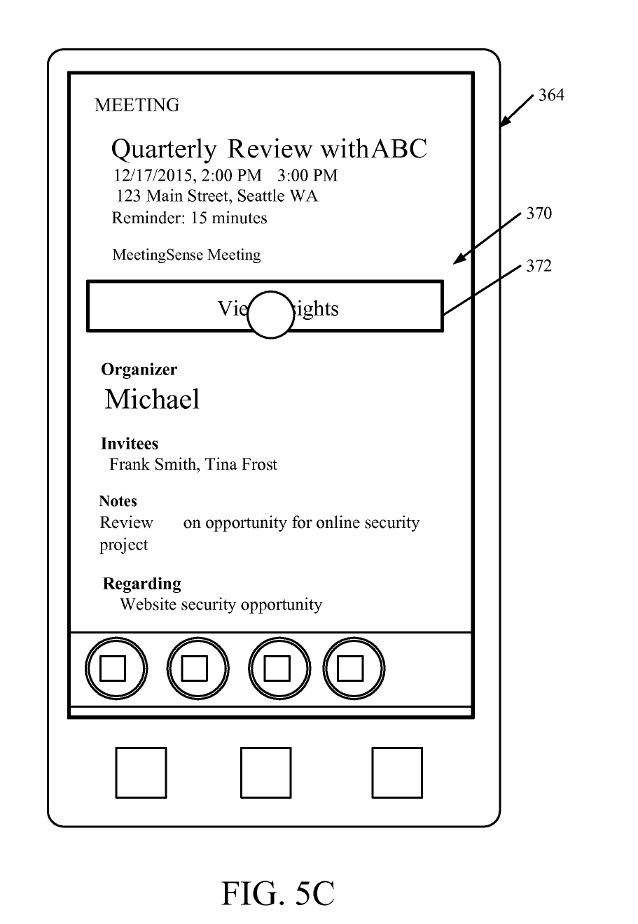

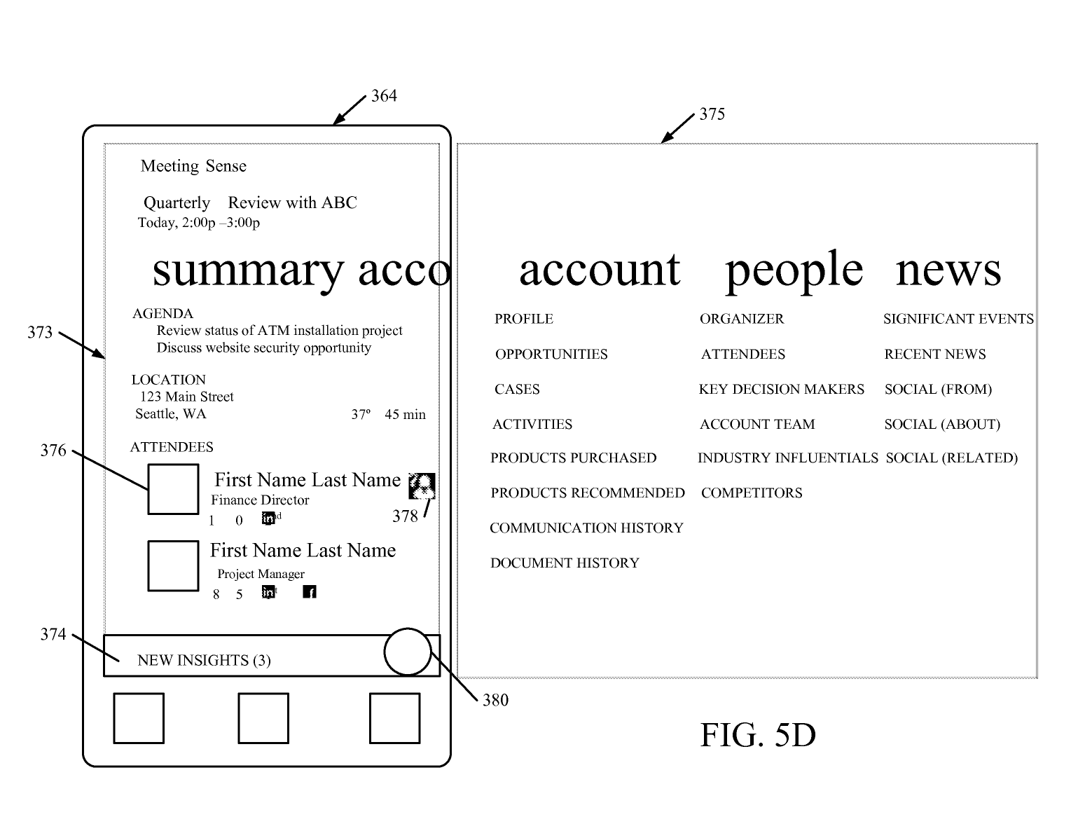

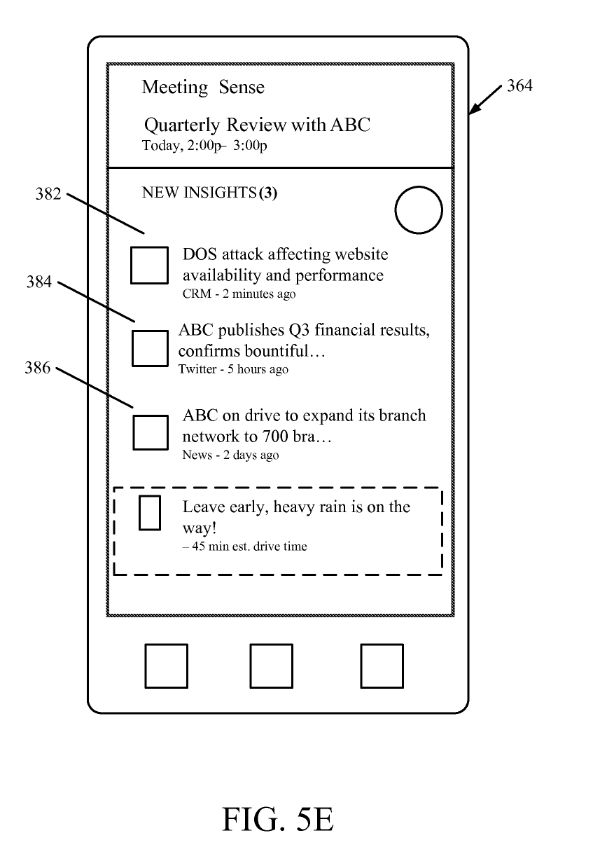

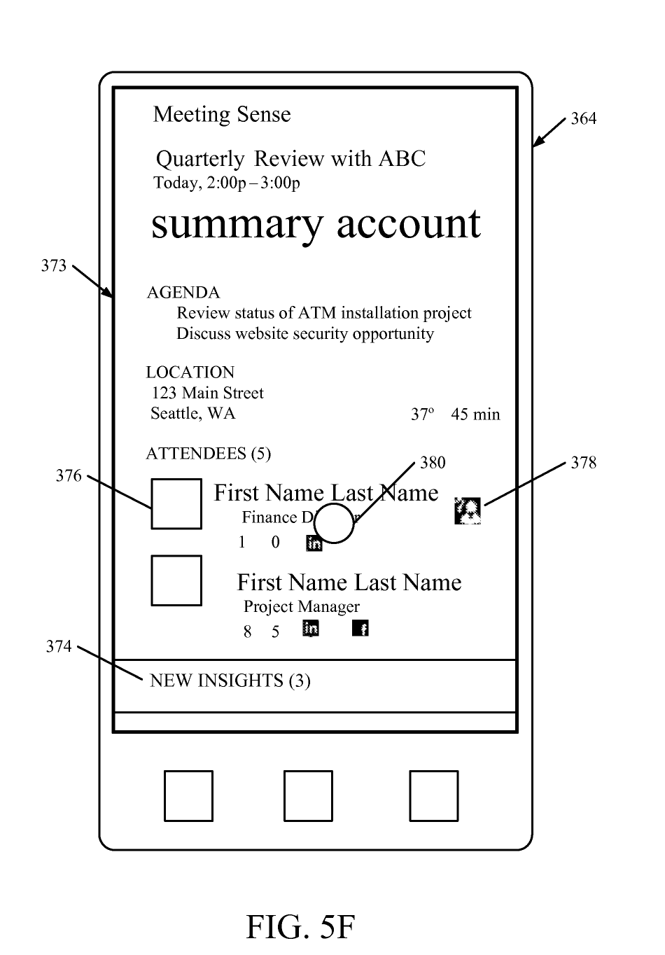

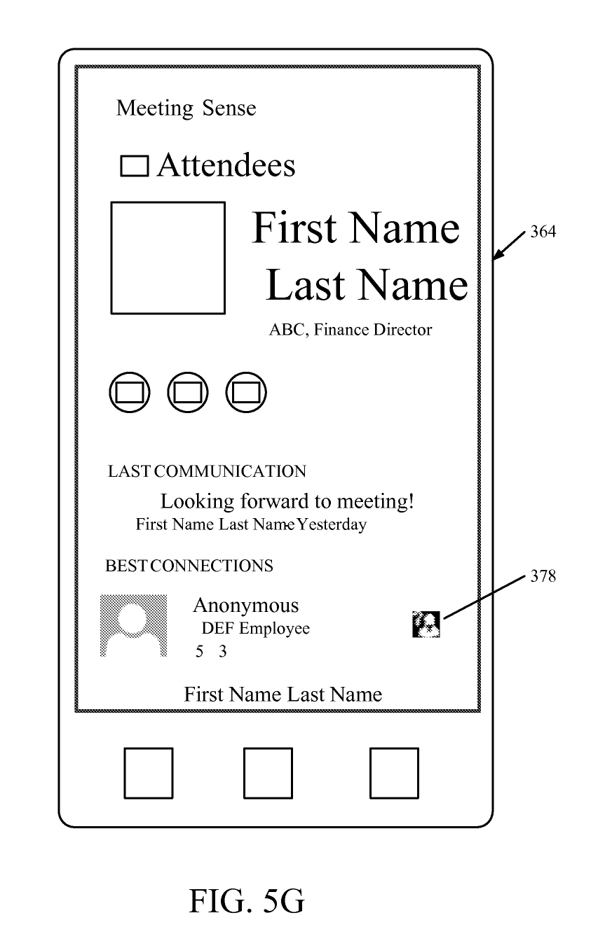

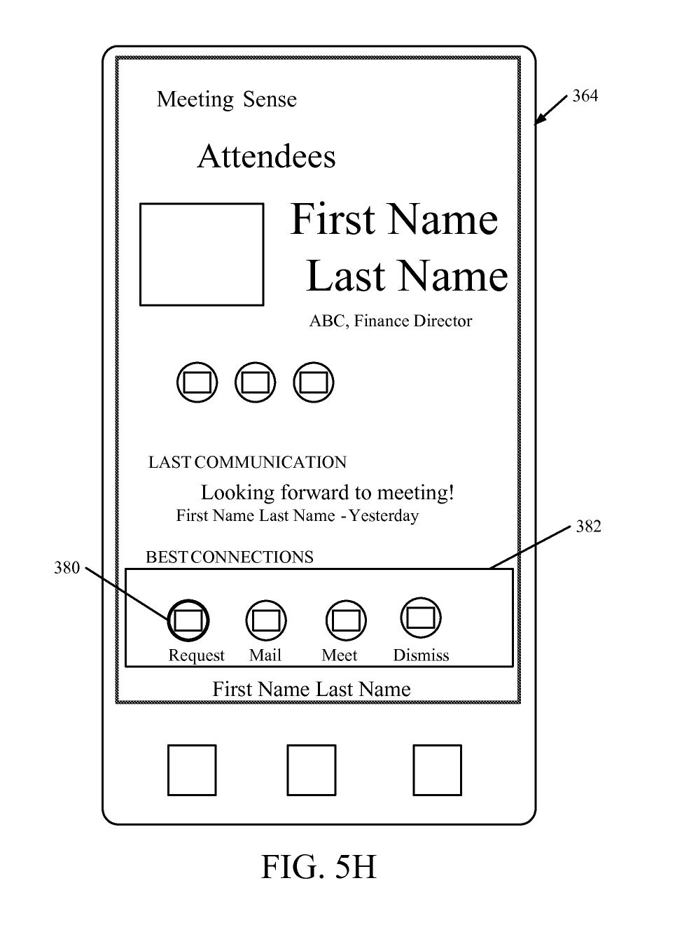

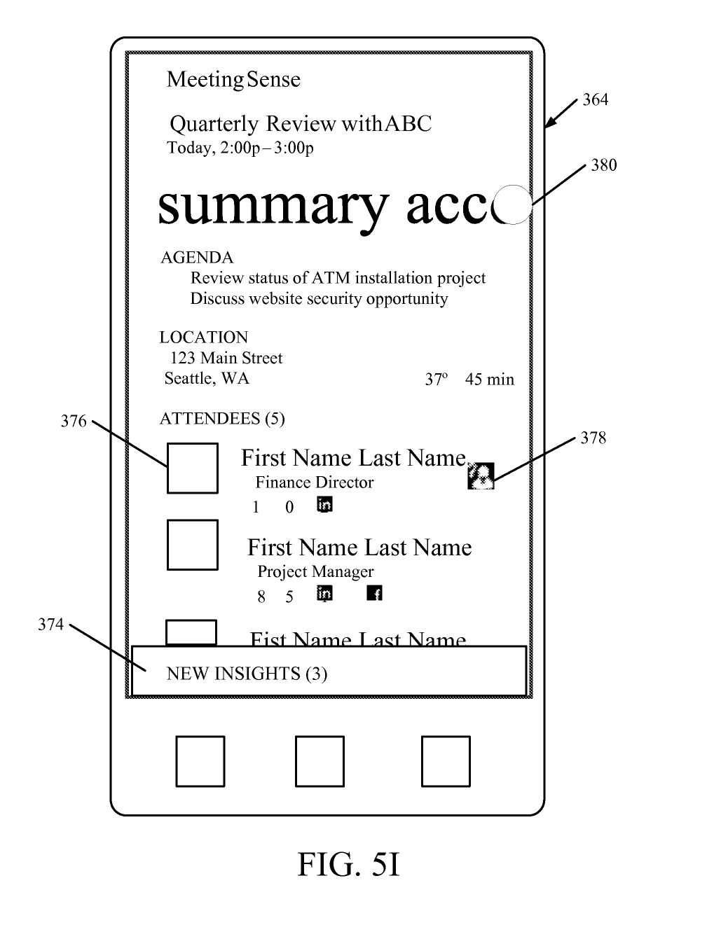

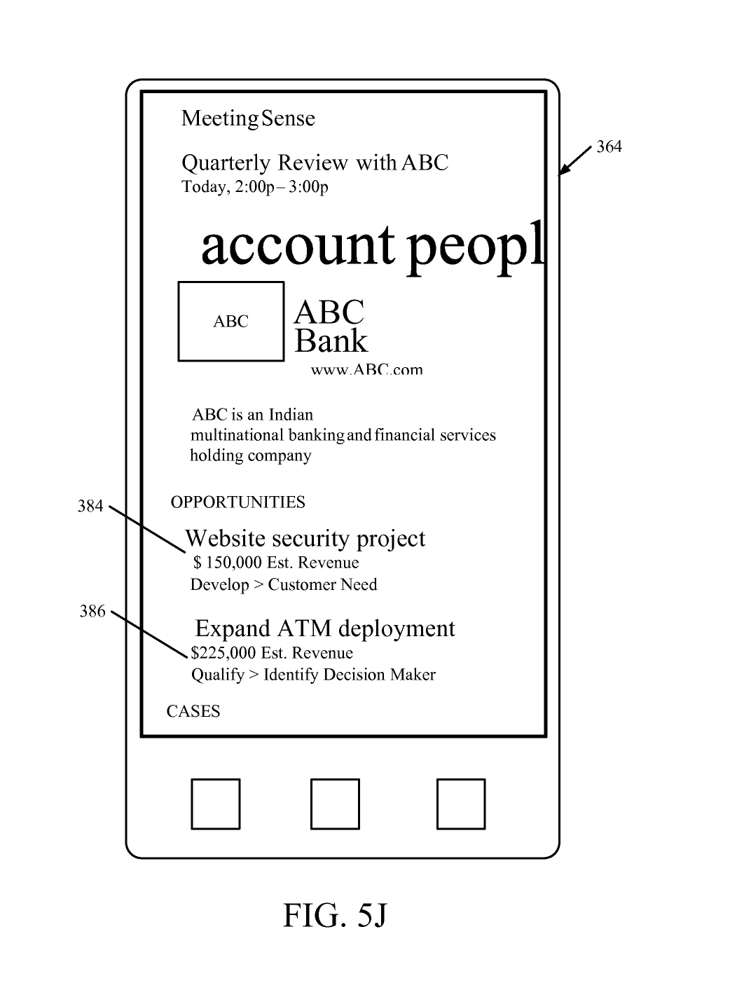

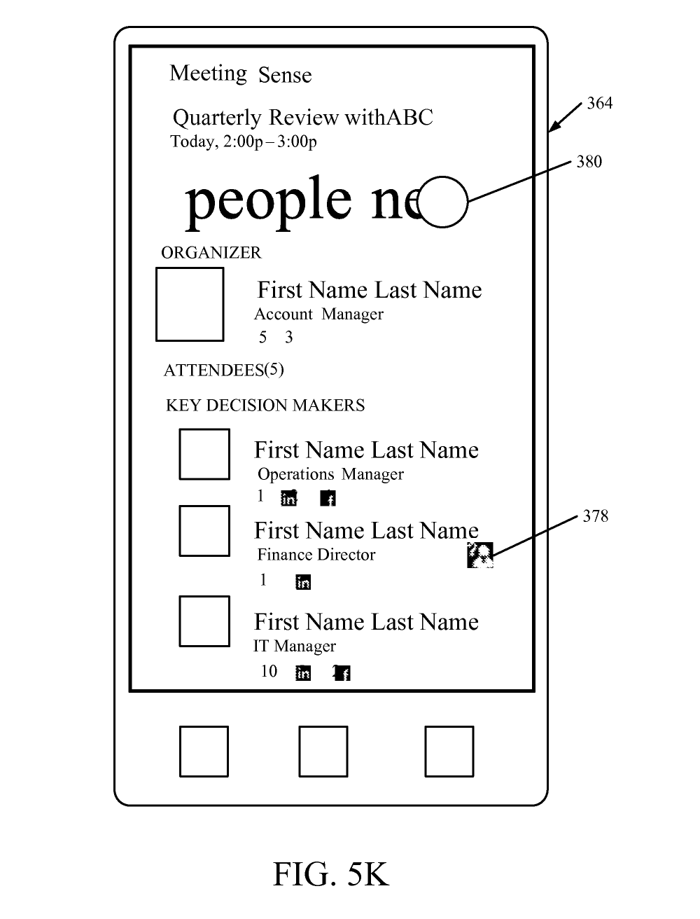

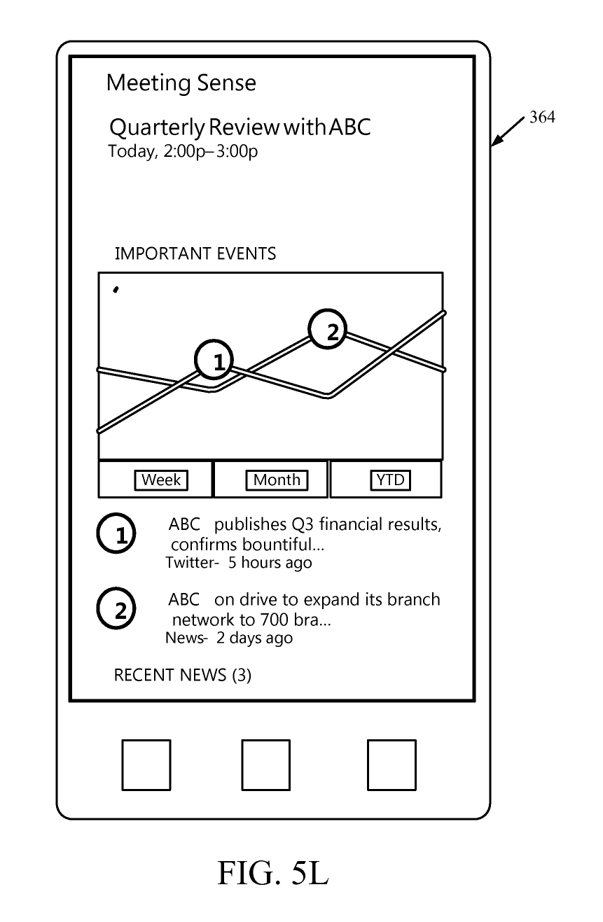

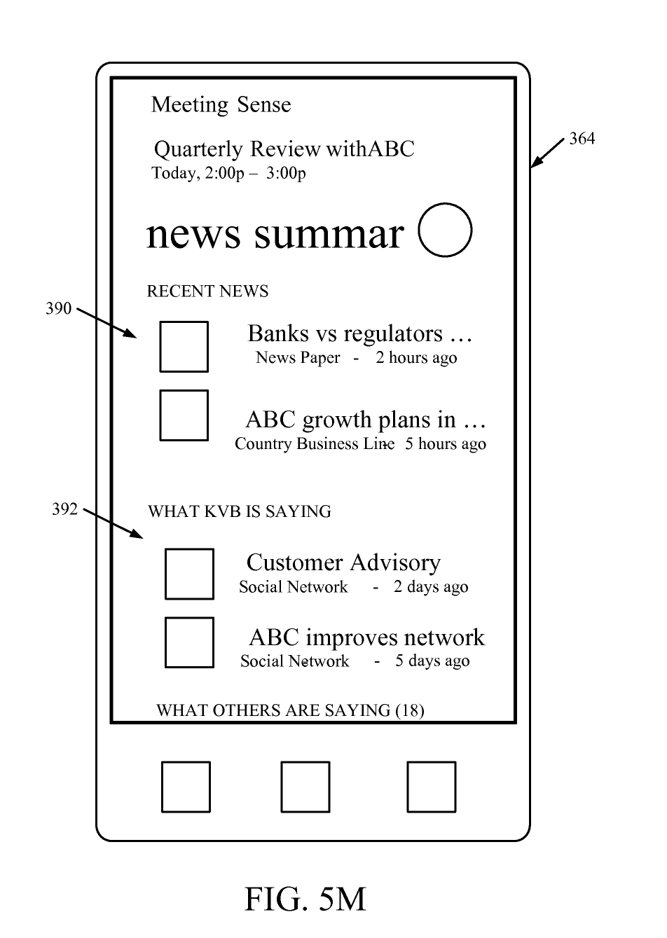

FIGS. 5A-5M show examples of user interface displays that can be generated on a mobile device 364 of an insight requestor (such as user 114). The discussion on FIGS. 5A-5M will follow a scenario in which user 114 of mobile device 364 is looking for insights with respect to a meeting that the user 114 has scheduled. Therefore, as shown in FIG. 5A, user 114 can first actuate a calendar user input mechanism 366 to view the user's calendar. That is, the user interacts with a calendar or meeting system in a client organization application 160 (shown in FIG. 1) on a client system 104. In response, the client organization application 160 displays the user's calendar, showing a meeting with ABC Company at 2:00 PM. The meeting link 368 is displayed in FIG. 5B. When the user actuates link 368, the user is illustratively navigated to a meeting display 370 shown in FIG. 5C.

Insight requestor UX component 174 illustratively detects these user interactions and extraction component 178 extracts the relevant information from them. Extraction component 178 can, for instance, determine that the user interaction corresponds to the user looking at a meeting notice for a particular meeting, that has particular invitees, and is with a particular organization, and extract this information. This information is illustratively provided to request generator 181 which generates an insight request and provides it to server system 108 which executes it against insight data store and index 110. If any responsive insight records are found, that are related to the particular meeting represented in the insight request, agent 194 indicates this to UX component 174 through client system 104. Component 174 then displays an insights link 372 indicating that there are certain insights that have been stored, and that are related to some aspects of the current meeting.

When the user actuates user input mechanism 372, then the system surfaces those insights which are publically available, or otherwise available without owner approval. It also illustratively surfaces a display element indicating that they are insights that need owner approval without revealing the content of those insights.

FIG. 5D shows one example of this. FIG. 5D displays a variety of more detailed information, corresponding to the meeting. In the example shown in FIG. 5D, it will be noted that the actual display is shown generally at 373. However, the display is illustratively pannable (or horizontally scrollable) to reveal other items as well, and they are generally shown at 375. Some or all of this information may be generated based on insight records identified in data store 110. For instance, it may be that the role of each of the attendees has been identified as an insight. It may also be that new insights, which have not yet been reviewed by this requestor, have been entered in the data store 110 as well. In that case, the system illustratively surfaces a user input mechanism 374 indicating that there are new insights.

FIG. 5D also shows that a sensitive insight is available with respect to the first attendee 376. For instance, a display element 378 is displayed next to attendee 376, and indicates that there is another insight regarding this individual, but the insight must be approved by the insight owner. Thus, display element 378 reveals the existence of a relevant insight record without revealing its content. In one example, the user input mechanism 378 is also a user actuatable link which can be actuated by the requestor (e.g., by tapping it, double tapping it, or otherwise selecting it) to initiate an approval request to the insight owner. This is described in greater detail below.

It can be seen in FIG. 5D, that the user has actuated the new insights user input mechanism 374 as indicated by circle 380. In that case, the system identifies whether any of the new insights are sensitive, and, if not, surfaces them for the requestor. This is shown in FIG. 5E. It can be seen in FIG. 5E that a display element is displayed corresponding to each of the three new insights as indicated generally at 382, 384 and 386. In one example, the display elements 382-286 illustratively display summary information corresponding to each of the insights. However, they are also illustratively a user actuatable input mechanism that can be interacted with by the user to see more detailed information or to perform other actions. For instance, if the user taps on one of the display elements 382-386, the component 174 illustratively retrieves more detailed information corresponding to the insight and displays it for the user.

It should also be noted that the insights can come from a wide variety of different sources. In one example, for instance, when insight identifier component 176 is identifying insights, they may be classified into one of a number of different event types. Those event types may vary based on the particular industry or context in which the system is deployed, or for other reasons. Some examples of event types that may be detected and classified as insights may be event types that indicate earning reports, leadership changes, new offerings by a company, merger and acquisition activity, partnerships, an indication that an organization is expanding operations or performing cost cutting, legal activity related to an organization, funding activity, bankruptcy and restructuring, etc. Of course, these are examples only. In the example shown in FIG. 5E, display element 382 corresponds to a news item that reflects an attack affecting a website. The insight corresponding to display element 384 corresponds to a financial report and that corresponding to display element 386 corresponds to an indication that the business is expanding.

FIG. 5F is similar to the display shown in FIG. 5D, and similar items are similarly numbered. However, it can be seen in FIG. 5F that the requestor has now actuated the display element 376 corresponding to the attendee that owns a sensitive insight indicated by display element 378. The system then displays more information corresponding to attendee 376, and one example of this is shown in FIG. 5G. The display shown in FIG. 5G now shows that the sensitive insight corresponds to a relationship that attendee 376 has with a contact at DEF Company. However, it can be seen that the identity of that contact is still not revealed.

If the user actuates the display element 378, then UX component 174 illustratively generates a request user input mechanism, such as mechanism 380 shown in FIG. 5H. Mechanism 380 includes a request user input mechanism 382 that can be actuated by the requestor in order to request that Robert Smithfield (who is the owner of a sensitive insight shown in FIG. 5G) be asked to approve the surfacing of that sensitive insight to the current requestor. It can be seen in FIG. 5H that the user is actuating user input mechanism 382 to request such approval. In that case, then as described above with respect to FIG. 4, request routing component 192 generates a request that is transmitted to the owner of the sensitive insight, requesting that the owner approve the insight for surfacing to the requestor. If the owner approves it, then it is surfaced for the requestor. If not, a suitable message can be generated for the requestor indicating that the approval has been denied.

FIGS. 5I-5M show that insights can be surfaced for other portions of the meeting display as well. For instance, in FIG. 5I, it can be seen that the user is now actuating the “accounts” user input mechanism. In that case, the application switches to show insights corresponding to the account that is the subject of the meeting. In the example shown in FIG. 5J, the account corresponds to ABC Bank. Therefore, insights related to that account are displayed. For instance, a number of opportunities may be recently opened in a CRM system, and a display elements 384-386 can be displayed corresponding to each of those insights. When those opportunities were opened, they can be detected as insights by component 176, and stored in data store 110. If the user actuates any of the display elements 384-386, then the user can illustratively be navigated to more detailed information corresponding to each of those insights.

FIG. 5K shows that the user has now actuated the “People” user input mechanism, and insights related to people at the ABC Bank. FIG. 5K thus identifies people and their roles or titles, as well as key decision makers, etc. FIG. 5K also shows that the user can illustratively actuate a “News” user input mechanism. FIG. 5L shows one example of a display that surfaces insights when the user does this. Again, the important news events can be monitored by using search engine 125 (either automatically or manually) to search various news sites or company sites, or by using social network or business network systems 136 and 138 or in other ways. Component 176 illustratively classifies news items based on their content into various important event types and server system 108 stores records related to those event types as insight records in data store 110. They can then be surfaced at an appropriate time. FIG. 5M shows that some of the insights correspond to earnings, financial results, articles about expanding the business, etc. FIG. 5N shows another user interface display that can be generated when the user actuates the “News” user input mechanism. It can include a set of recent news items shown generally at 390, a set of social or business network items at 392, among other things.

It can thus be seen that the present system provides significant advantages over prior systems. For instance, it automatically detects a wide variety of different types of user interactions with various components of the computing system. It identifies certain interactions as insights that may be surfaced at later times. It does this for even sensitive or private content or private material. It can obtain approval by the owner of the material to store an insight, and it can then again obtain approval of the owner to surface the insight for various users. Thus, the owner of the insight, even if the insight contains sensitive material, can quickly and easily authorize the insight to be surfaced for users, when desired, but otherwise the insight will not be surfaced. The presence of the insight will be made known to other users, but its content will not be surfaced.

This enhances the efficiency of the system. Instead of users needing to perform multiple queries against the system to find relevant information, that information is automatically detected, stored, and later surfaced. This reduces network traffic and queries against the various data stores in the system, thus greatly improving system efficiency. It also enhances the security of sensitive data. It can generate insight records from sensitive data, but leaves the question of whether the records are generated or stored, and the subsequent dissemination of those records, in the hands of the insight owner.

Further, it improves efficiency of the various users. The users can quickly and easily see whether any insights exist in various contexts. They can readily see publicly available insights, and they can also request that insights containing sensitive material be surfaced for them. Similarly, the insight owners can quickly and easily authorize or deny such requests, thus increasing his or her efficiency as well.

Further, because the system identifies when an insight is relevant to a given user, the owner of the insight need not attempt to convey the insight to all interested users. It will be brought to their attention, as and when it is needed. Thus, it enhances the performance of the computing system itself, it enhances security of data within the system, and it enhances the performance efficiency of the users of the system.

The present discussion has mentioned processors and servers. In one embodiment, the processors and servers include computer processors with associated memory and timing circuitry, not separately shown. They are functional parts of the systems or devices to which they belong and are activated by, and facilitate the functionality of the other components or items in those systems.

Also, a number of user interface displays have been discussed. They can take a wide variety of different forms and can have a wide variety of different user actuatable input mechanisms disposed thereon. For instance, the user actuatable input mechanisms can be text boxes, check boxes, icons, links, drop-down menus, search boxes, etc. They can also be actuated in a wide variety of different ways. For instance, they can be actuated using a point and click device (such as a track ball or mouse). They can be actuated using hardware buttons, switches, a joystick or keyboard, thumb switches or thumb pads, etc. They can also be actuated using a virtual keyboard or other virtual actuators. In addition, where the screen on which they are displayed is a touch sensitive screen, they can be actuated using touch gestures. Also, where the device that displays them has speech recognition components, they can be actuated using speech commands.

A number of data stores have also been discussed. It will be noted they can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

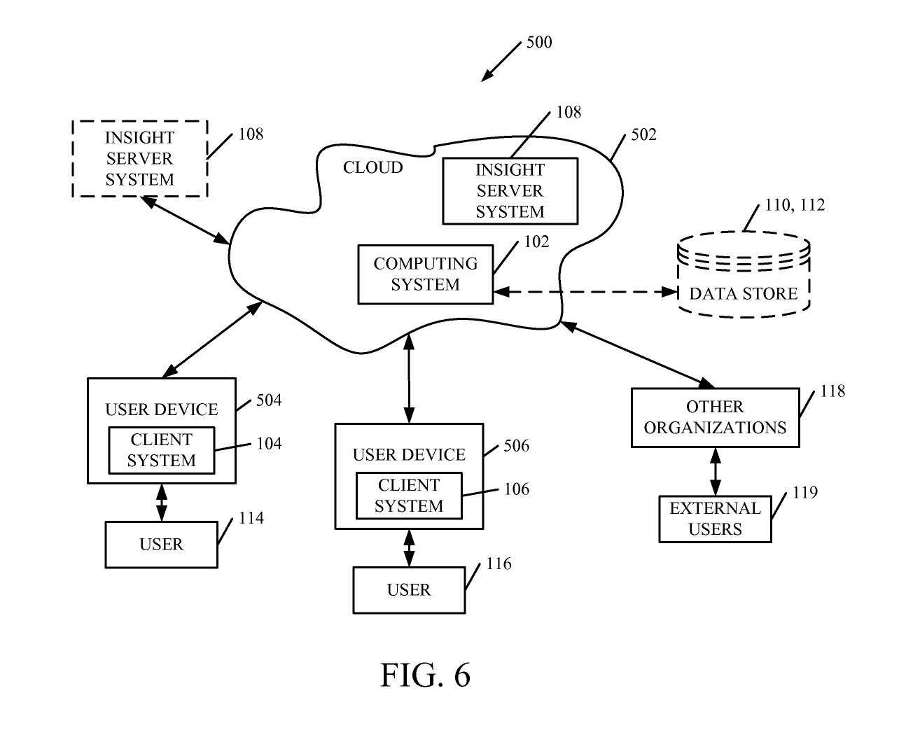

FIG. 6 is a block diagram of architecture 100, shown in FIG. 1, except that its elements are disposed in a cloud computing architecture 500. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of architecture 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

In the example shown in FIG. 6, some items are similar to those shown in FIG. 1 and they are similarly numbered. FIG. 6 specifically shows that computing system 102 and system 108 can be located in cloud 502 (which can be public, private, or a combination where portions are public while others are private). Therefore, users 114 and 116 use user devices 504 and 506 that include client systems 104 and 106 to access those systems through cloud 502.

FIG. 6 also depicts another example of a cloud architecture. FIG. 6 shows that it is also contemplated that some elements of computing system 102 and system 108 can be disposed in cloud 502 while others are not. By way of example, data stores 110 and 112 can be disposed outside of cloud 502, and accessed through cloud 502. In another example, insight server system 108 or parts of system 102 can be outside of cloud 502. Regardless of where they are located, they can be accessed directly by devices 504 and 506, through a network (either a wide area network or a local area network), they can be hosted at a remote site by a service, or they can be provided as a service through a cloud or accessed by a connection service that resides in the cloud. All of these architectures are contemplated herein.

It will also be noted that architecture 100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

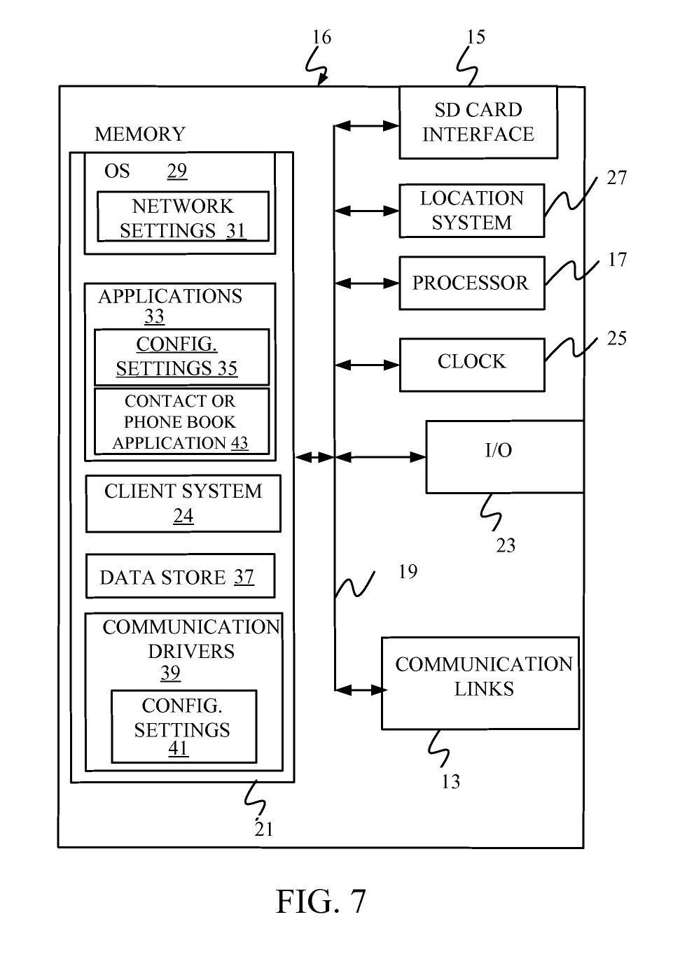

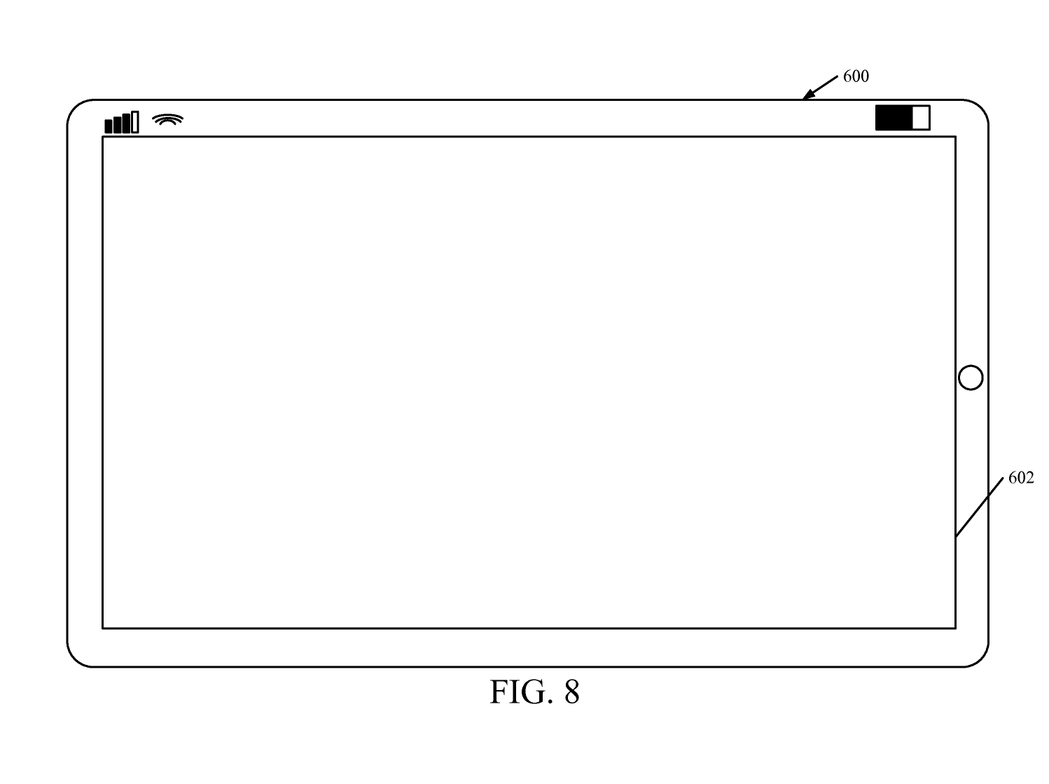

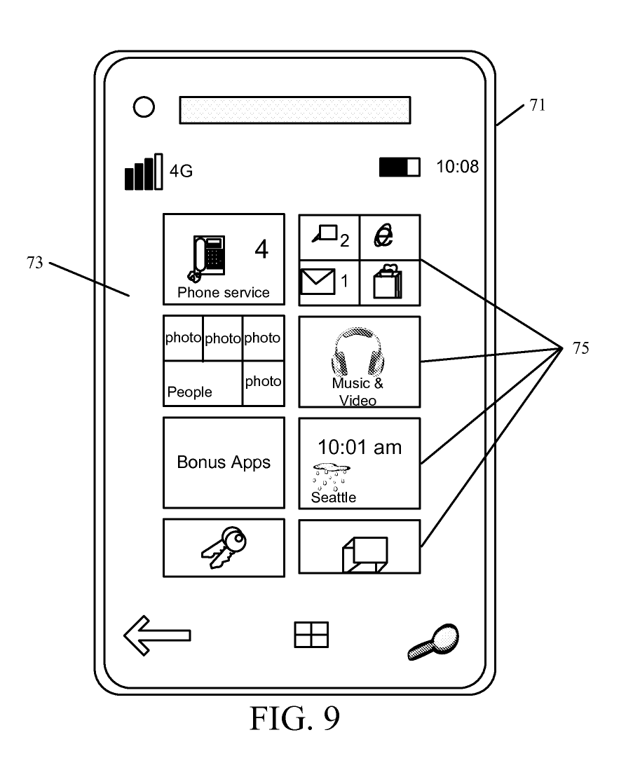

FIG. 7 is a simplified block diagram of one illustrative embodiment of a handheld or mobile computing device that can be used as a user's or client's hand held device 16, in which the present system (or parts of it) can be deployed. FIGS. 8-9 are examples of handheld or mobile devices.

FIG. 7 provides a general block diagram of the components of a client device 16 that can run components of system 102, system 106 or system 108 or that interacts with architecture 100, or both. In the device 16, a communications link 13 is provided that allows the handheld device to communicate with other computing devices and under some embodiments provides a channel for receiving information automatically, such as by scanning. Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1×rtt, and Short Message Service, which are wireless services used to provide cellular access to a network, as well as Wi-Fi protocols, and Bluetooth protocol, which provide local wireless connections to networks.

Under other embodiments, applications or systems are received on a removable Secure Digital (SD) card that is connected to a SD card interface 15. SD card interface 15 and communication links 13 communicate with a processor 17 (which can also embody processors 126, 154 or 187 from FIGS. 1 and 2) along a bus 19 that is also connected to memory 21 and input/output (I/O) components 23, as well as clock 25 and location system 27.

I/O components 23, in one embodiment, are provided to facilitate input and output operations. I/O components 23 for various embodiments of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. Similarly, device 16 can have a client system 24 (which can be system 162 from FIG. 1) which can run various applications or embody parts or all of architectures 100 or 170. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

FIG. 8 shows one embodiment in which device 16 is a tablet computer 600. In FIG. 6, computer 600 is shown with user interface display screen 602. Screen 602 can be a touch screen (so touch gestures from a user's finger can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 600 can also illustratively receive voice inputs as well.

Additional examples of devices 16 can also be used. Device 16 can be a feature phone, smart phone or mobile phone. The phone can include a set of keypads for dialing phone numbers, a display capable of displaying images including application images, icons, web pages, photographs, and video, and control buttons for selecting items shown on the display. The phone can include an antenna for receiving cellular phone signals such as General Packet Radio Service (GPRS) and 1×rtt, and Short Message Service (SMS) signals. In some examples, the phone also includes a Secure Digital (SD) card slot that accepts a SD card.

The mobile device can also be a personal digital assistant or a multimedia player or a tablet computing device, etc. (hereinafter referred to as a PDA). The PDA can include an inductive screen that senses the position of a stylus (or other pointers, such as a user's finger) when the stylus is positioned over the screen. This allows the user to select, highlight, and move items on the screen as well as draw and write. The PDA can also include a number of user input keys or buttons which allow the user to scroll through menu options or other display options which are displayed on the display, and allow the user to change applications or select user input functions, without contacting the display. The PDA can include an internal antenna and an infrared transmitter/receiver that allow for wireless communication with other computers as well as connection ports that allow for hardware connections to other computing devices. Such hardware connections are typically made through a cradle that connects to the other computer through a serial or USB port. As such, these connections are non-network connections. FIG. 9 shows that the phone can be a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

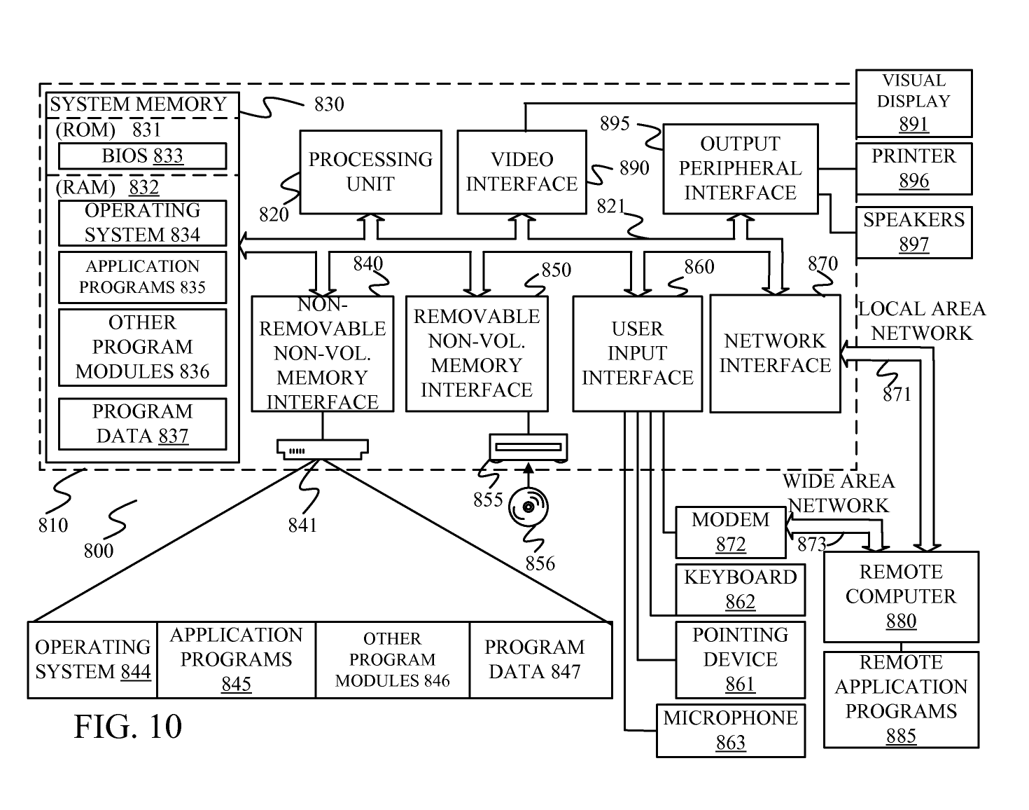

FIG. 10 is one embodiment of a computing environment in which architecture 100, or parts of it, (for example) can be deployed. With reference to FIG. 10, an exemplary system for implementing some embodiments includes a general-purpose computing device in the form of a computer 810. Components of computer 810 may include, but are not limited to, a processing unit 820 (which can comprise processor or servers 126, 154 or 187), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to the previous figures can be deployed in corresponding portions of FIG. 10.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 10 illustrates operating system 834, application programs 835, other program modules 836, and program data 837.

The computer 810 may also include other removable/non-removable volatile/nonvolatile computer storage media. By way of example only, FIG. 10 illustrates a hard disk drive 841 that reads from or writes to non-removable, nonvolatile magnetic media, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 10, provide storage of computer readable instructions, data structures, program modules and other data for the computer 810. In FIG. 10, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 10 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 10 illustrates remote application programs 885 as residing on remote computer 880. It will be appreciated that the network connections shown are exemplary and other means of establishing a communications link between the computers may be used.

It should also be noted that the different embodiments described herein can be combined in different ways. That is, parts of one or more embodiments can be combined with parts of one or more other embodiments. All of this is contemplated herein.

Example 1 is a computing system, comprising:

an insight request generator that generates an insight request for insight records related to detected user interaction information and that receives a responsive insight record, responsive to the insight request;

a sensitive material identifier identifying whether the responsive insight record includes sensitive material for which approval is to be sought; and

a user experience component that generates an insight user interface display that displays an insight presence display indicating that a responsive insight record is identified that is related to the user interaction information and that approval is to be obtained from an owner of the responsive insight record, before contents of the responsive insight record are to be revealed.

Example 2 is the computing system of any or all previous examples wherein the user experience component generates the insight presence display as a user actuatable approval request input mechanism and that detects actuation of the approval request user input mechanism.

Example 3 is the computing system of any or all previous examples wherein the user experience component, in response to detected actuation of the approval request input mechanism, generates an approval request that is routed to the owner of the responsive insight record.

Example 4 is the computing system of any or all previous examples wherein the user experience component receives an approval input indicative of the owner of the responsive insight record approving the approval request and, in response, displays content of the responsive insight record.

Example 5 is the computing system of any or all previous examples wherein the insight request generator generates the insight request based on detected user interaction information that comprises an express request for insight records.

Example 6 is the computing system of any or all previous examples wherein the insight request generator automatically generates the insight request based on detected user interaction information that comprises a user interaction with an organization application for a given organization.

Example 7 is the computing system of any or all previous examples and further comprising:

an extraction component that extracts the user interaction information from the detected user interaction.

Example 8 is the computing system of any or all previous examples and further comprising:

an insight identification component that detects a new insight based on the extracted user interaction information, wherein the sensitive material identifier identifies whether the extracted user interaction information includes sensitive material.

Example 9 is the computing system of any or all previous examples and further comprising:

a notification component that controls the user experience component to display an insight creation approval user input mechanism for an owner of the insight and that detects user actuation of the insight creation approval user input mechanism.

Example 10 is the computing system of any or all previous examples and further comprising:

an insight record generator that, in response to actuation of the insight creation approval user input mechanism, generates an insight record representing the insight and sends the insight record to a storage system.

Example 11 is a computing system, comprising:

a user interface component that detects a user interaction;

an extraction component that extracts user interaction information from the detected user interaction;

an insight identification component that detects an insight based on the extracted user interaction information;

a sensitive material identifier that identifies whether the extracted user interaction information includes sensitive material for which approval is to be sought;

a notification component that controls the user interface component to display an approval user input mechanism for an owner of the insight and that detects user actuation of the approval user input mechanism; and

an insight record generator that, in response to actuation of the approval user input mechanism, generates an insight record representing the insight, including a sensitivity indicator indicative of whether the sensitive material is included, and sends the insight record to a storage system.

Example 12 is the computing system of any or all previous examples wherein the insight identification component identifies the insight as one of a pre-defined set of insights based on the extracted user interaction information.

Example 13 is the computing system of any or all previous examples wherein the insight identification component comprises:

a rules-based insight identification component that identifies the insight by applying a set of insight definition rules to the extracted user interaction information.

Example 15 is the computing system of any or all previous examples wherein the insight identification component comprises:

a machine learning insight identification component.

Example 15 is the computing system of any or all previous examples wherein the insight identification component comprises:

a classifier component that classifies the extracted user interaction information into one of a set of insight classes, each representing a different type of insight.

Example 16 is the computing system of any or all previous examples wherein the insight record generator generates the insight record according to a pre-defined schema.

Example 17 is the computing system of any or all previous examples wherein the insight record generator generates the insight record according to a selected one of a plurality of pre-defined schemas, the selected one being selected based on the user interaction information.

Example 18 is the computing system of any or all previous examples and further comprising:

a strength engine that generates a strength metric indicative of a strength of the insight relative to the extracted user interaction information, the insight record generator including the strength metric in the insight record.

Example 18 is a computing system, comprising:

a request agent that receives an insight request indicative of user interaction information representing a user interaction with a user interface component;

a matching component that matches the insight request against stored insight records to identify a stored, responsive insight record that is responsive to the insight request; and

a request routing component that identifies whether the responsive insight record includes sensitive material for which approval is to be sought and, if so, identifies an owner of the responsive insight record and sends an approval request to the owner of the responsive insight record, the approval request including an approval user input mechanism, the request routing component receiving actuation information indicative of the owner actuating the approval user input mechanism and, in response, returning the responsive insight record in response to the insight request.

Example 20 is the computing system of any or all previous examples and further comprising:

a ranking component that ranks responsive insight records based on a set of ranking criteria, and wherein the request routing component identifies whether each of a top N responsive insight records includes sensitive material for which approval is to be sought and, if so, identifies an owner of each of the top N responsive insight records that contain sensitive material and sends an approval request to the owner of each of the responsive insight records that contain sensitive material, the approval request including an approval user input mechanism, the request routing component receiving actuation information indicative of the owners actuating the approval user input mechanisms and, in response, returning the top N responsive insight records in response to the insight request.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computing system, comprising:
an insight request generator that generates an insight request for insight records related to detected user interaction information and that receives a responsive insight record, responsive to the insight request;
a sensitive material identifier identifying whether the responsive insight record includes sensitive material for which approval is to be sought; and
a user experience component that generates an insight user interface display that displays an insight presence display indicating that a responsive insight record is identified that is related to the user interaction information and that approval is to be obtained from an owner of the responsive insight record, before contents of the responsive insight record are to be revealed.

2. The computing system of claim 1 wherein the user experience component generates the insight presence display as a user actuatable approval request input mechanism and that detects actuation of the approval request user input mechanism.

3. The computing system of claim 2 wherein the user experience component, in response to detected actuation of the approval request input mechanism, generates an approval request that is routed to the owner of the responsive insight record.

4. The computing system of claim 3 wherein the user experience component receives an approval input indicative of the owner of the responsive insight record approving the approval request and, in response, displays content of the responsive insight record.

5. The computing system of claim 4 wherein the insight request generator generates the insight request based on detected user interaction information that comprises an express request for insight records.

6. The computing system of claim 4 wherein the insight request generator automatically generates the insight request based on detected user interaction information that comprises a user interaction with an organization application for a given organization.

7. The computing system of claim 4 and further comprising:
an extraction component that extracts the user interaction information from the detected user interaction.

8. The computing system of claim 7 and further comprising:
an insight identification component that detects a new insight based on the extracted user interaction information, wherein the sensitive material identifier identifies whether the extracted user interaction information includes sensitive material.

9. The computing system of claim 8 and further comprising:
a notification component that controls the user experience component to display an insight creation approval user input mechanism for an owner of the insight and that detects user actuation of the insight creation approval user input mechanism.

10. The computing system of claim 9 and further comprising:
an insight record generator that, in response to actuation of the insight creation approval user input mechanism, generates an insight record representing the insight and sends the insight record to a storage system.

11. A computing system, comprising:
a user interface component that detects a user interaction;
an extraction component that extracts user interaction information from the detected user interaction;
an insight identification component that detects an insight based on the extracted user interaction information;
a sensitive material identifier that identifies whether the extracted user interaction information includes sensitive material for which approval is to be sought;
a notification component that controls the user interface component to display an approval user input mechanism for an owner of the insight and that detects user actuation of the approval user input mechanism; and
an insight record generator that, in response to actuation of the approval user input mechanism, generates an insight record representing the insight, including a sensitivity indicator indicative of whether the sensitive material is included, and sends the insight record to a storage system.

12. The computing system of claim 11 wherein the insight identification component identifies the insight as one of a pre-defined set of insights based on the extracted user interaction information.

13. The computing system of claim 12 wherein the insight identification component comprises:
a rules-based insight identification component that identifies the insight by applying a set of insight definition rules to the extracted user interaction information.

14. The computing system of claim 13 wherein the insight identification component comprises:
a machine learning insight identification component.

15. The computing system of claim 11 wherein the insight identification component comprises:
a classifier component that classifies the extracted user interaction information into one of a set of insight classes, each representing a different type of insight.

16. The computing system of claim 11 wherein the insight record generator generates the insight record according to a pre-defined schema.

17. The computing system of claim 11 wherein the insight record generator generates the insight record according to a selected one of a plurality of pre-defined schemas, the selected one being selected based on the user interaction information.

18. The computing system of claim 11 and further comprising:
a strength engine that generates a strength metric indicative of a strength of the insight relative to the extracted user interaction information, the insight record generator including the strength metric in the insight record.

19. A computing system, comprising:
a request agent that receives an insight request indicative of user interaction information representing a user interaction with a user interface component;
a matching component that matches the insight request against stored insight records to identify a stored, responsive insight record that is responsive to the insight request; and
a request routing component that identifies whether the responsive insight record includes sensitive material for which approval is to be sought and, if so, identifies an owner of the responsive insight record and sends an approval request to the owner of the responsive insight record, the approval request including an approval user input mechanism, the request routing component receiving actuation information indicative of the owner actuating the approval user input mechanism and, in response, returning the responsive insight record in response to the insight request.

20. The computing system of claim 19 and further comprising:
a ranking component that ranks responsive insight records based on a set of ranking criteria, and wherein the request routing component identifies whether each of a top N responsive insight records includes sensitive material for which approval is to be sought and, if so, identifies an owner of each of the top N responsive insight records that contain sensitive material and sends an approval request to the owner of each of the responsive insight records that contain sensitive material, the approval request including an approval user input mechanism, the request routing component receiving actuation information indicative of the owners actuating the approval user input mechanisms and, in response, returning the top N responsive insight records in response to the insight request.
